(19) United States
(12) Patent Application Publication
(10) Pub. No.: US 2016/0176469 A1
(43) Pub. Date: Jun. 23, 2016

(54) Leg controlled operation mechanism for electric balance vehicle

(71) Applicant: Ninebot(Tianjin) Technology Co., Ltd., Tianjin (CN)

(72) Inventors: Hui Zhang, Tianjin (CN); Ye Wang, Tianjin (CN); Zhenyuan Zhang, Tianjin (CN); Wei Wei, Tianjin (CN)

(73) Assignee: Ninebot(Tianjin) Technology Co., Ltd.

(21) Appl. No.: 14/547,071

(22) Filed: Nov. 18, 2014

(30) Foreign Application Priority Data
Jun. 30, 2014 (CN) 201420357564.6

(51) Int. Cl. B62K 23/08

(52) U.S. Cl. CPC B62K 23/08

(57) ABSTRACT

A controlled operation mechanism for an electric balance vehicle includes: a controlled operation support and a leg controlled portion. A bottom of the controlled operation support is mounted on a rotating operation axle of the electric balance vehicle; and the leg controlled portion is mounted on a top of the controlled operation support; in such a manner that steering of the electric balance vehicle is capable of being controlled only by both legs, so as to free both hands of the driver for other operations such as taking a photograph, which enhances experiences of users.

### CROSS REFERENCE OF RELATED APPLICATION

The present application claims priority under 35 U.S.C. 119(a-d) to CN 201420357564.6, filed Jun. 30, 2014.

### BACKGROUND OF THE PRESENT INVENTION

1. Field of Invention

The present invention relates to the field of a scooter, and more particularly to a leg controlled operation mechanism for an electric balance vehicle.

2. Description of Related Arts

Electric balance vehicle or self-balance vehicle is an advanced short distance vehicle, such as the Ninebot series of self-balance scooter robots on current market, wherein using electricity as power, the posture and condition of the vehicle is sensed through an attitude measurement sensor consisting of a built-in microcomputer gyroscope and an accelerometer, and control commands are computed through a high-speed processor to drive the motor and move the vehicle.

Control styles of the electric balance vehicle or the self-balance vehicle evolve from an accelerator, a brake and a steering wheel which is similar to handle bars of a bicycle into a left and right swinging mechanism with a gravity sensor. While steering, the body of a user inclines with a rotating direction, which counteracts a centrifugal force during the process of steering in a disguised way. Left and right swinging support is more humane to operate than a horizontally rotating handle bar or a steering wheel.

The operating mode of the left and right swinging operation mechanism actually belongs to a vertically swinging steering. In the conventional art, the left and right swinging operation support is usually directly operated by hands. Thus, during the utilization process of a balance vehicle, a driver can hardly perform other operations with the hands, such as taking a photograph, which leads to bad experiences of users.

### SUMMARY OF THE PRESENT INVENTION

In order to solve the technical problems mentioned above, the present invention provides a leg controlled operation mechanism for an electric balance vehicle, so as to free both hands of a driver for other operations such as taking a photograph, which enhances experiences of users.

In order to solve the technical problems mentioned above, the present invention provides a leg controlled operation mechanism for an electric balance vehicle, comprising: a controlled operation support and a leg controlled portion;

wherein a bottom of the controlled operation support is for mounting to a rotating operation axle of the electric balance vehicle; and

wherein the leg controlled portion is mounted on a top of the controlled operation support.

Preferably, according to a preferred embodiment of the present invention, the leg controlled operation mechanism further comprises a connector, wherein the leg controlled portion is mounted on the top of the controlled operation support via the connector.

Preferably, according to another preferred embodiment of the present invention, the connector has a threaded hole, wherein the leg controlled portion is mounted on the top of the controlled operation support via the threaded hole.

Preferably, according to another preferred embodiment of the present invention, a rubber cushion is provided on the leg controlled portion.

Preferably, according to another preferred embodiment of the present invention, the rubber cushion has a frame structure.

Preferably, according to another preferred embodiment of the present invention, the connector has a threaded hole, and the rubber cushion is mounted on a surface of the leg controlled portion via the threaded hole.

Compared with the conventional arts, the leg controlled operation mechanism of the present invention comprises: the controlled operation support and the leg controlled portion, wherein the bottom of the controlled operation support is mounted on the rotating operation axle of the electric balance vehicle; and the leg controlled portion is mounted on the top of the controlled operation support; in such a manner that steering of the electric balance vehicle is capable of being controlled only by both legs, so as to free both hands of the driver for other operations such as taking a photograph, which enhances experiences of users.

### BRIEF DESCRIPTION OF THE DRAWINGS

FIG. 1 is a side view of a leg controlled operation mechanism according to a first preferred embodiment of the present invention.

FIG. 2 is a top view of the leg controlled operation mechanism according to the first preferred embodiment of the present invention.

FIG. 3 is a perspective view of the leg controlled operation mechanism according to the first preferred embodiment of the present invention.

FIG. 4 is a motion diagram of the leg controlled operation mechanism according to a second preferred embodiment of the present invention.

FIG. 5 is a perspective view of a first rubber cushion according to a third preferred embodiment of the present invention.

FIG. 6 is a top view of the first rubber cushion according to the third preferred embodiment of the present invention.

FIG. 7 is a perspective view of a second rubber cushion according to a fourth preferred embodiment of the present invention.

FIG. 8 is a top view of the second rubber cushion according to the fourth preferred embodiment of the present invention.

FIG. 9 is a sketch view showing a first connection of the leg controlled operation mechanism and a rotating operation axle according to a fifth preferred embedment of the present invention.

FIG. 10 is a sketch view showing a second connection of the leg controlled operation mechanism and the rotating axle according to a sixth preferred embedment of the present invention.

FIG. 11 is a sketch view of a first telescoping mechanism according to a seventh preferred embodiment of the present invention.

FIG. 12 is a sketch view of a second telescoping mechanism according to an eighth preferred embodiment of the present invention.

### DETAILED DESCRIPTION OF THE PREFERRED EMBODIMENT

These and other objectives, features, and advantages of the present invention will become apparent from the following detailed description, the accompanying drawings, and the appended claims. One skilled in the art will understand that the embodiment of the present invention as shown in the drawings and described above is exemplary only and not intended to be limiting.

According to a preferred embodiment of the present invention, a controlled operation mechanism for an electric balance vehicle comprises: a controlled operation support and a leg controlled portion;

wherein a bottom of the controlled operation support is mounted on a rotating operation axle of the electric balance vehicle; and the leg controlled portion is mounted on a top of the controlled operation support; in such a manner that steering of the electric balance vehicle is capable of being controlled only by both legs, so as to free both hands of the driver for other operations such as taking a photograph, which enhances experiences of users.

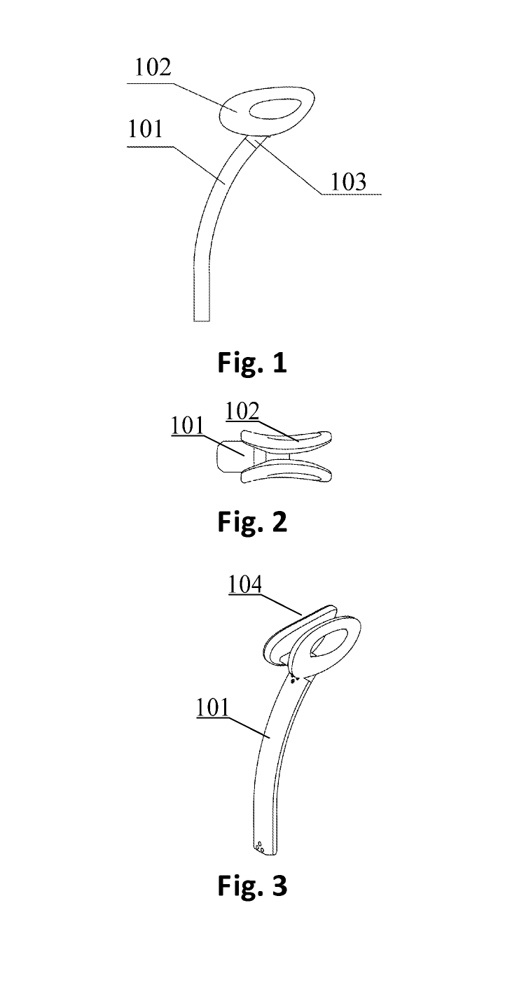

FIG. 1 is a side view of a leg controlled operation mechanism according to a first preferred embodiment of the present invention. FIG. 2 is a top view of the leg controlled operation mechanism according to the first preferred embodiment of the present invention. FIG. 3 is a perspective view of the leg controlled operation mechanism according to the first preferred embodiment of the present invention.

Referring to FIGS. 1-3, a leg controlled operation mechanism for an electric balance vehicle comprises: a controlled operation support 101 and a leg controlled portion 102;

wherein a bottom of the controlled operation support 101 is for mounting to a rotating operation axle of the electric balance vehicle; and

wherein the leg controlled portion 102 is mounted on a top of the controlled operation support 101.

Preferably, the controlled operation support 101 and the leg controlled portion 102 adopt a separate structure. Thus, in order to install the leg controlled portion 102 onto the controlled operation support 101, the leg controlled operation mechanism further comprises a connector 103 for mounting the leg controlled portion 102 on the top of the controlled operation support 101.

Preferably, when the connector 103 is adopted to mount the leg controlled portion 102, the connector 103 has a threaded hole (not shown in the Figs.). The leg controlled portion 102 is mounted on the top of the controlled operation support 101 via the threaded hole.

Preferably, in order to facilitate controls on the controlled operation support by a left side and a right side of both knees on both legs of the driver to provide a good buffer, a rubber cushion 104 is provided on the leg controlled portion 102. Specifically, the rubber cushion 104 has a frame structure.

Preferably, the connector 103 has a threaded hole (not shown in the Figs), and the rubber cushion is mounted on a surface of said leg controlled portion 102 via said threaded hole.

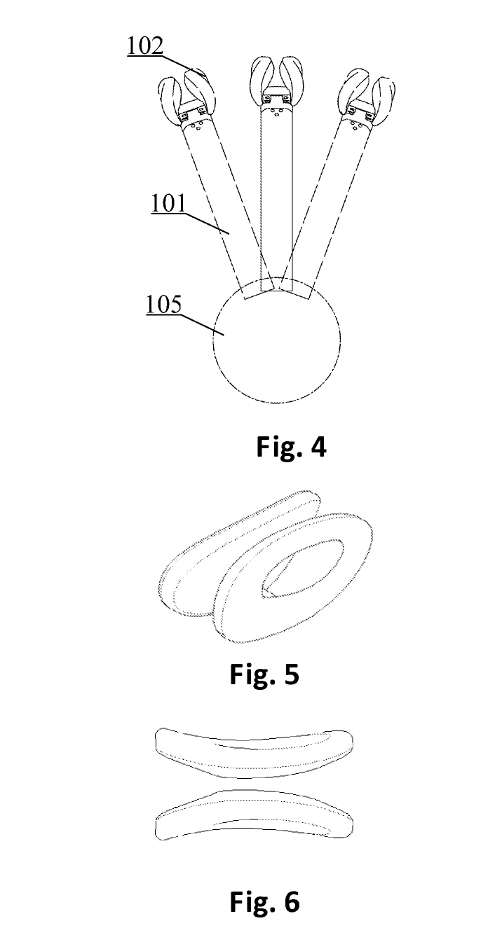

FIG. 4 is a motion diagram of the leg controlled operation mechanism according to a second preferred embodiment of the present invention. As shown in FIG. 4, knees portions of an operator lean against positions of the rubber cushion and both legs swing left and right, so as to apply forces on a whole of the leg controlled operation mechanism, in such a manner that the controlled operation support 101 rotates around the rotating operation axle 105 of the electric balance vehicle. The left and right rotating motion is converted into a control instruction to control steering of the electric balance vehicle. Thus, the driver does not need a hand to operate, and the hand of the drivers can be utilized for shooting a camera or a photo and etc.

It is worth mentioning that, according to another preferred embodiment of the present invention, a detachable band is further provided on the leg controlled portion 102 to bind the knee portions of the driver and drive the whole of the controlled operation support 101 to move, in such a manner that steering control is achieved. Details are not further illustrated here.

It is worth mentioning that, in the second preferred embodiment mentioned above, the controlled operation support 101 and the leg controlled portion 102 adopt the separate structure. According to another preferred embodiment of the present invention, the controlled operation support 101 and the leg controlled portion 102 form an integrated body without the connector.

FIG. 5 is a perspective view of a first rubber cushion according to a third preferred embodiment of the present invention. FIG. 6 is a top view of the first rubber cushion according to the third preferred embodiment of the present invention. As shown in FIGS. 5-6, the rubber cushion has the frame structure, wherein an external shape thereof is analogous to a round shape, and a portion for receiving a leg is an arc surface.

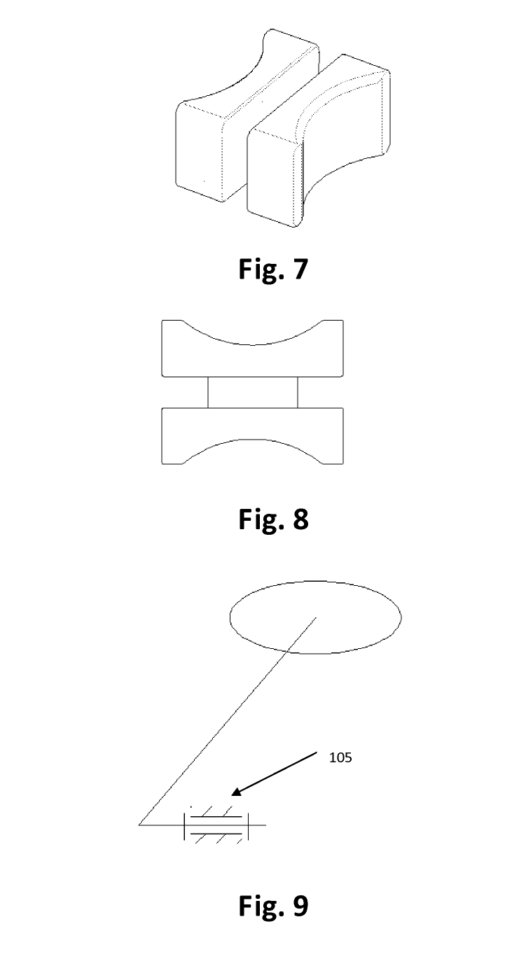

FIG. 7 is a perspective view of a second rubber cushion according to a fourth preferred embodiment of the present invention. FIG. 8 is a top view of the second rubber cushion according to the fourth preferred embodiment of the present invention. As shown in FIGS. 7-8, the rubber cushion has the frame structure, wherein an external shape thereof is analogous to a square shape, and the portion for receiving the leg is the arc surface as well.

FIG. 9 is a sketch view showing a first connection of the leg controlled operation mechanism and a rotating operation axle according to a fifth preferred embedment of the present invention. As shown in FIG. 9, the leg controlled operation mechanism is connected with the rotating operation axle 105 which is horizontally provided. Left and right swings of the leg controlled operation mechanism drive the rotating operation axle 105 to rotate let and right. It is worth mentioning that, in order to connect the rotating operation axle 105 provided horizontally, a whole of the operation support of the leg controlled operation mechanism is in a shape of an “L”.

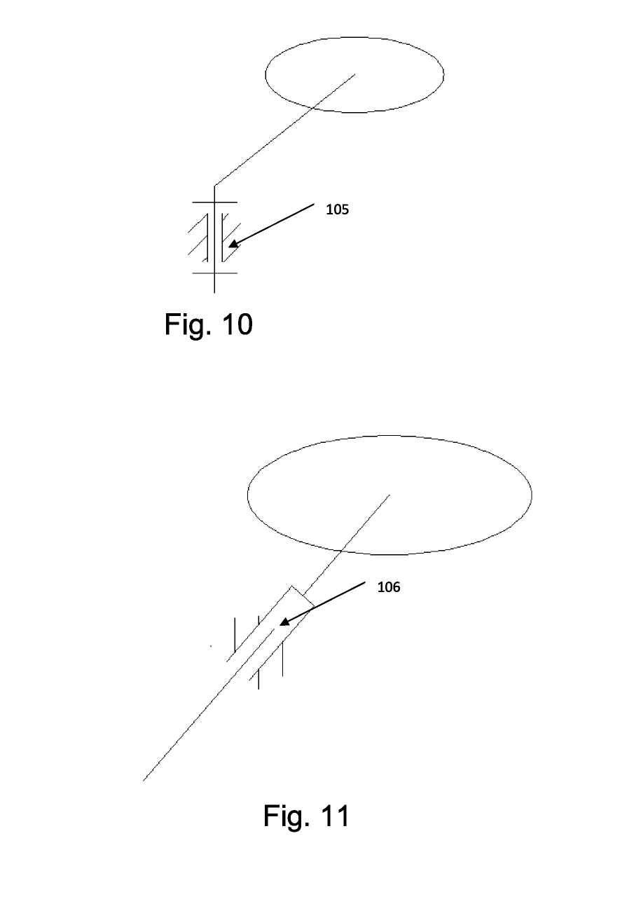

FIG. 10 is a sketch view showing a second connection of the leg controlled operation mechanism and the rotating axle according to a sixth preferred embedment of the present invention. As shown in FIG. 10, the leg controlled operation mechanism is connected with the rotating operation axle 105 which is vertically provided. The left and right swings of the leg controlled operation mechanism drive the rotating operation axle 105 to rotate left and right. It is worth mentioning that, since the rotating operation axle 105 is vertically provided, the rotating operation axle 105 is capable of directly connecting with the bottom of the operation support of the leg controlled operation mechanism.

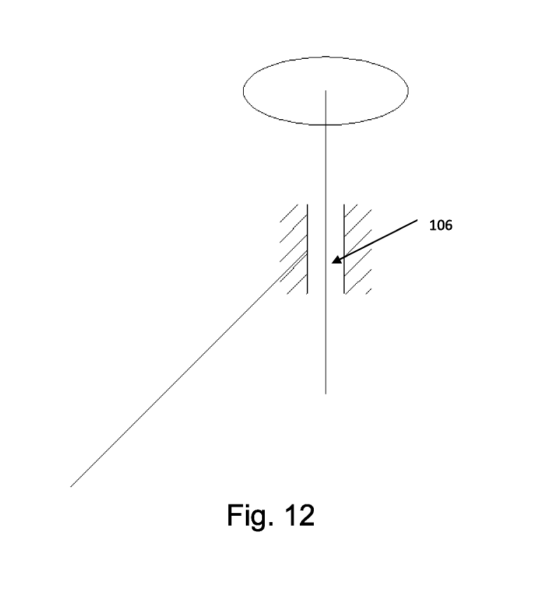

FIG. 11 is a sketch view of a first telescoping mechanism according to a seventh preferred embodiment of the present invention. As shown in FIG. 11, a telescoping mechanism 106 is provided on a middle portion of the controlled operation support 101, wherein the telescoping mechanism 106 has a slant included angle with a ground, in such a manner that the leg controlled operation mechanism stretches out and retracts back along a direction slanted towards the ground, so as to change a length of the controlled operation support 101.

FIG. 12 is a sketch view of a second telescoping mechanism according to an eighth preferred embodiment of the present invention. As shown in FIG. 12, the telescoping mechanism 106 is provided on the middle portion of the controlled operation support 101, wherein the telescoping mechanism 106 is vertical to the ground, in such a manner that the leg controlled operation mechanism stretches out and retracts back along a direction vertical to the ground, so as to change a length of the controlled operation support 101.

The above description illustrates certain preferred embodiments of the present invention, but as previously said, it should be understood that the use of the present invention is not limited to the examples given herein and other preferred embodiments should not be excluded. It can be used in various other combinations, modifications, and environments, and within the outline given by this present invention. Variations can be made in accordance with the above guidelines and related knowledge or technology in the related arts. Therefore, this invention includes all modifications encompassed within the spirit and scope of the following claims.

What is claimed is:

1. A leg controlled operation mechanism for an electric balance vehicle, comprising: a controlled operation support and a leg controlled portion;
wherein a bottom of said controlled operation support is for mounting to a rotating operation axle of said electric balance vehicle; and
wherein said leg controlled portion is mounted on a top of said controlled operation support.

2. The leg controlled operation mechanism, as recited in claim 1, further comprising a connector, wherein said leg controlled portion is mounted on said top of said controlled operation support via said connector.

3. The leg controlled operation mechanism, as recited in claim 2, wherein said connector has a threaded hole, wherein said leg controlled portion is mounted on said top of said controlled operation support via said threaded hole.

4. The leg controlled operation mechanism, as recited in claim 1, wherein a rubber cushion is provided on said leg controlled portion.

5. The leg controlled operation mechanism, as recited in claim 4, wherein said rubber cushion has a frame structure.

6. The leg controlled operation mechanism, as recited in claim 4, wherein said connector has a threaded hole, and said rubber cushion is mounted on a surface of said leg controlled portion via said threaded hole.

7. The leg controlled operation mechanism, as recited in claim 1, further comprising a telescoping mechanism provided on a middle portion of said controlled operation support.
